(19) United States
(12) Patent Application Publication
(10) Pub. No.: US 2002/0008147 A1
(43) Pub. Date: Jan. 24, 2002

(54) Manufacture of chip cards with detachable module

(75) Inventors: Gerard Coiton, Venelles (FR); Augustin Farrugia, La Ciotat (FR)

Correspondence Address: ROLAND PLOTTEL, Rockefeller Center Station, P.O. Box 293, New York, NY, 10185, US

(73) Assignee: Gemplus Card International

(21) Appl. No.: 09/734,061

(22) Filed: Dec. 11, 2000

Related U.S. Application Data
(63) Continuation of application No. 08/452,379, filed on May 26, 1995, now abandoned.
Application No. 08/452,379 is a continuation of application No. 07/905,906, filed on Jun. 29, 1992, now abandoned.

(30) Foreign Application Priority Data
Jul. 2, 1991 (FR) 91 08248

(51) Int. Cl. G06K 19/06

(52) U.S. Cl. 235/492

(57) ABSTRACT

The invention concerns a method for the making of chip cards, wherein the entire manufacturing method is carried out on a standard format card, and then a chip card with a smaller format than the standard format is cut out from this card.

### BACKGROUND OF THE INVENTION

The invention relates to electronic microcircuit cards, more generally known as chip cards.

One of the problems frequently encountered with respect to products distributed on a very large scale is that of standardization when products made by different manufacturers have to be used in the same instruments.

This is especially the case with chip cards: these are used, for example, in public telephones, card readers associated with personal computers, banking applications etc. It has therefore been necessary to adopt precise standards of manufacture that have to be met by all manufacturers. The-general public is now well aware of the format that has been adopted, at least as regards the external dimensions of the card: this is the format of standard credits cards with magnetic tracks. The chip card is a rectangle, about 8.5 cm. long by 5.4 cm wide, with a thickness of a little less than one millimeter (current international standards IS 7816-1 and 7816-2).

The result thereof, naturally, is that the chip card manufacturing machines are built as a function of these standards, to enable the production of cards that meet the standards.

However, in certain applications, it is seen that this format is not an ideal one. This is especially so for miniaturized applications. For example, when a chip card has to be used in a very small-sized package, it is not certain that the present format, despite its small size, will remain acceptable. For example, we may cite the future digital radiotelephone, the portable package is likely to use chip cards with a far smaller format than the present one.

### SUMMARY OF THE INVENTION

The invention is aimed at proposing an economical technical approach to the making of chip cards with a smaller format than the one generally used.

According to the invention, it is proposed to make the chip cards in the most common standard format and then to cut them out.

In an especially advantageous way, it is proposed that the standard format cards will be provided with a partial and local pre-cut outline having the desired dimensions around the microcircuit contained in the card.

This partial pre-cut outline makes it possible, notably, to detach a card with predetermined reduced dimensions from the card with standard dimensions.

The detaching is done only after the end of all the manufacturing, testing and customized printing operations, so that it is possible to use all the standard manufacturing and testing machines without any strains due to the reduced dimensions desired for the final card.

Consequently, the manufacturing cost is reduced since it is not necessary to invest in additional, costly manufacturing machines just because of these problems of dimensions.

There is another major advantage of the pre-cut outline made around the micromodule that exists also when the pre-cut part is not detached: the card continues to be a standard format card. In this case, the part within the pre-cut outline, namely the part that contains the electronic micromodule, is mechanically uncoupled from the card, i.e. it undergoes far fewer bending and torsional stresses due to the handling of the card.

The preliminary cutting-out operation may be a reduction of the thickness of the card throughout the reduced format card. It may also be a cutting out of an outline throughout the thickness, with small uncut regions being left from place to place to form bridges between the reduced format card and the rest of the standard format card. These bridges hold the reduced format card in the standard format card until the final detaching operation.

### BRIEF DESCRIPTION OF THE DRAWINGS

Other features and advantages of the invention shall appear from the following description, made with reference to the the appended drawings, of which:

FIG. 1 shows a standard chip card in the present standard format used for the majority of applications;

FIG. 2 shows the principle of the invention for the making of a card with reduced format;

FIG. 3 shows the completed card;

FIG. 4 shows an enlarged view of an example of the preliminary cutting out of an outline by means of interrupted slots wherein bridges of material are allowed to remain;

FIG. 5 shows an sectional view of another exemplary embodiment wherein the preliminary cutting out is done by reducing the thickness of the entire rim of the card.

### DETAILED DESCRIPTION OF THE INVENTION

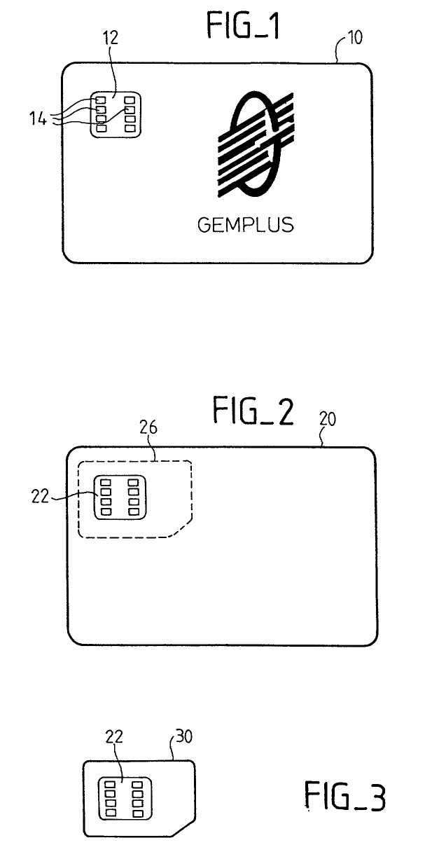

FIG. 1 shows a highly conventional chip card 10 with a flat rectangular flat format: length 8.5 cm; width 5.4 cm, thickness smaller than one millimeter. The electronic micromodule 12 which forms the core of the card is placed in the top left-hand corner. The contacts 14 providing access to this micromodule are flush with the surface of the card. Outside the zone that is flush with the surface of the card, the rest of the card may be used for customized recordings for the supplier of the service or for the user: this is also the case for the rear face of the card.

FIG. 2 shows the implementation of the invention: starting with a card 20 of a standard format, identical to that of FIG. 1, the entire manufacturing process is carried out: this includes the testing of the micromodule 22 (once this micromodule has been positioned in the card with the flush contacts), and the customizing of the surfaces of the card by the printing of texts and graphic material.

However, the final card will be far smaller and its contour is shown in FIG. 2 by means of a dashed line 26 surrounding the micromodule 22. The card will be cut out along the line 26.

Several methods may be used and the cutting out can be done at various times during the manufacture. It could be done, for example, in a single operation at the end of manufacture.

According to the invention it is preferred, in an intermediate step, to carry out a partial cutting out operation and not a total cutting out operation. It is only at the stage of sending the product to the user, and even at the user's premises during the insertion of the card into a reader corresponding to the reduced format standard, that the reduced format card will be detached from the standard format card by simple pressure.

FIG. 3 shows the reduced format card 30 that is finally obtained.

The partial cutting out may be done in several different ways. It consists in embrittling the rim of the line 26 in such a way that a simple pressure of the fingers between the card zone 30 and the remaining card zone 20 makes it possible to detach the card 30.

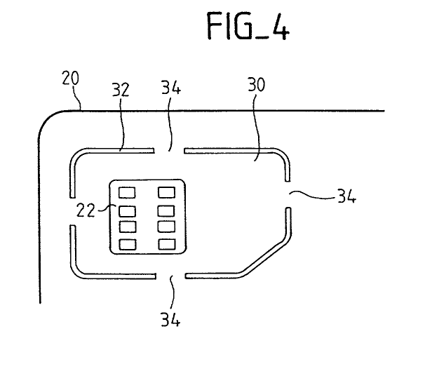

FIG. 4 shows a pre-cut outline consisting of a slot 32 throughout the thickness of the card; this slot extends on the rim of the card 30, except at certain positions of the line 26 where the slot is interrupted and leaves bridges 34 connecting the card 30 to the rest of the card 20. These bridges 34 themselves have a smaller thickness than the reduced format card to enable the separation of this card from the body of the standard format card.

It will be understood that with an embodiment such as that of FIG. 4 especially, if the number of bridges 34 is small (for example 4 as shown), an efficient mechanical uncoupling is achieved between the card 20 and the card 30; it is quite useful to take advantage of this coupling even when the cards remain in a standard format, to obtain a chip card that is less sensitive to bending and torsional stresses arising out of harsh conditions of use and storage by the ultimate user.

What is claimed is:

1. A method for the making of chip cards, wherein the entire manufacturing method is carried out on a standard format card, and then a chip card with a smaller format than the standard format is cut out from this card.

2. A method for the making of chip cards according to claim 1, comprising a step for the formation of a partial pre-cut outline around a micromodule of the card to enable a partial cutting out between a reduced format zone containing the micromodule and the rest of a card with a standard format.

3. A method for the making of chip cards according to claim 2, wherein a card with a reduced format smaller than the standard format is obtained at the end of manufacture by the separation of the reduced format card along a pre-cut outline.

4. A method according to either of the claims 2 or 3, wherein the pre-cut outline is constituted by a slot along the rim of the reduced format card, this slot being interrupted locally to leave, from place to place, bridges between the reduced format card and the rest of the standard format card, these bridges being reduced in thickness at the level of the reduced format card to enable the separation of said reduced format card from the body of the standard format card.
